(19) United States
(12) Patent Application Publication
(10) Pub. No.: US 2022/0385862 A1
(43) Pub. Date: Dec. 1, 2022

(54) IMAGING ASSEMBLY, MOVING DEVICE, CONTROL METHOD, AND RECORDING MEDIUM

(71) Applicant: CANON KABUSHIKI KAISHA, Tokyo (JP)

(72) Inventor: Naohiro Arai, Kanagawa (JP)

(21) Appl. No.: 17/824,642

(22) Filed: May 25, 2022

(30) Foreign Application Priority Data
May 31, 2021 (JP) 2021-091767

(51) Int. Cl. H04N 7/18; H04N 5/232; G06T 5/00; B60W 40/10; B60W 50/14

(52) U.S. Cl. CPC H04N 7/183; H04N 5/23232; G06T 5/006; B60W 40/10; B60W 50/14; B60W 2420/42; B60W 2420/905; B60W 2050/146

(57) ABSTRACT

The assembly mounted on a moving device includes an element, an optical system configured to form a high resolution image near an optical axis in a first region of a light receiving surface of the element and form a low resolution image of a peripheral portion separated from the optical axis in a second region wider than the first region of the light receiving surface of the element, a generation unit configured to generate a first captured image from pixel data in the first region and generate a second captured image from pixel data in the second region, and a control unit configured to selectively display the first captured image or the second captured image on a display unit in accordance with a moving direction of the moving device.

### BACKGROUND

### Technical Field

The aspect of the embodiments relates to an imaging assembly, a moving device, a control method, a recording medium, and the like.

### Description of the Related Art

Two different imaging devices can be installed at a rear portion of a moving device such as an automobile. A first imaging device is an imaging device that captures an image of a side behind and distant from the moving device at a narrow view angle to generate a captured image if the moving device travels forward. The captured image generated by the first imaging device is displayed on a rear view mirror type display unit which is referred to as an electronic mirror. A second imaging device is an imaging device that captures an image of a side behind and near the moving device at a wide view angle to generate a captured image if the moving device travels backward. The captured image generated by the second imaging device is displayed on a display unit which is referred to as a back monitor or a rear-view monitor.

One high-pixel camera installed at a rear portion of a vehicle is disclosed in Japanese Patent Laid-Open No. 2020-164115. The high-pixel camera disclosed in Patent Document 1 can function as an electronic mirror camera (equivalent to a first imaging device) and can also function as an electronic rear-view camera (equivalent to a second imaging device).

When a frame rate of a captured image (a captured image at a narrow view angle) which is generated by the first imaging device is low if a moving device travels forward at a high speed, the movement of a subject displayed on the electronic mirror becomes intermittent, which results in a situation that the visibility with the electronic mirror deteriorates. However, it is assumed that the high-pixel camera disclosed in Patent Document 1 reads all pieces of pixel data of a high-pixel sensor to generate any one of a captured image having a narrow view angle and a captured image having a wide view angle. For this reason, the high-pixel camera disclosed in Patent Document 1 has to read all pieces of pixel data of the high-pixel sensor even when it generates a captured image having a narrow view angle.

Thus, the high-pixel camera disclosed in Japanese Patent Laid-Open No. 2020-164115 has an issue that it takes time to generate a captured image having a narrow view angle and an issue that it is not possible to increase a frame rate of the captured image having a narrow view angle. A method using a high-pixel sensor capable of performing high-speed reading is conceivable as a method for improving the issues, but in this method, an image processing circuit capable of performing high-speed image processing is required, which results in an issue that the cost of the imaging device increases.

### SUMMARY

An assembly according to the aspect of the embodiments is an assembly mounted on a moving device, the assembly including an element, an optical system configured to form a high resolution image near an optical axis in a first region of a light receiving surface of the element and form a low resolution image of a peripheral portion separated from the optical axis in a second region wider than the first region of the light receiving surface of the element, at least one processor and a memory coupled to the processor storing instructions that, when executed by the processor, cause the processor to function as an image generation unit configured to generate a first captured image from pixel data in the first region and generate a second captured image from pixel data in the second region, and a control unit configured to selectively display the first captured image or the second captured image on a display unit in accordance with a moving direction of the moving device.

Further features of the present disclosure will become apparent from the following description of embodiments with reference to the attached drawings.

### BRIEF DESCRIPTION OF THE DRAWINGS

FIG. 1 is a side view of a moving device 10 in an embodiment.

FIG. 2 is a block diagram illustrating a configuration of an imaging assembly 20 that can be installed in the moving device 10.

FIGS. 3A to 3C are diagrams illustrating a positional relationship between a light receiving surface 141 of an imaging element 140 and a subject image formed by an optical system 110.

FIGS. 4A and 4B are diagrams illustrating a relationship between a read region of the imaging element 140 and a frame rate.

FIG. 5 is a flowchart illustrating imaging control processing performed by the imaging assembly 20.

### DESCRIPTION OF THE EMBODIMENTS

Hereinafter, with reference to the accompanying drawings, favorable modes of the present disclosure will be described using embodiments. In each diagram, the same reference signs are applied to the same members or elements, and duplicate description will be omitted or simplified.

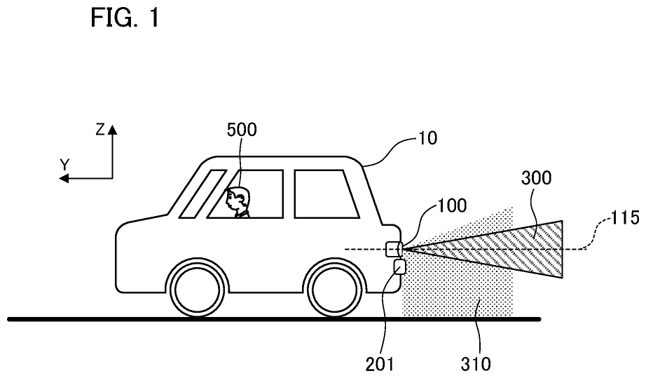

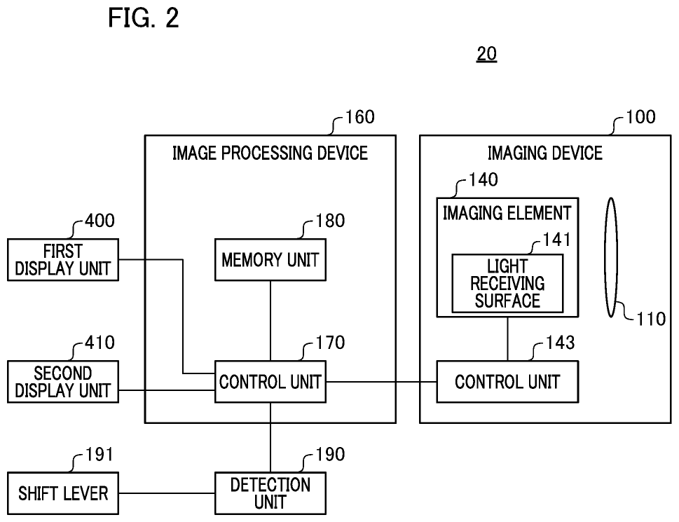

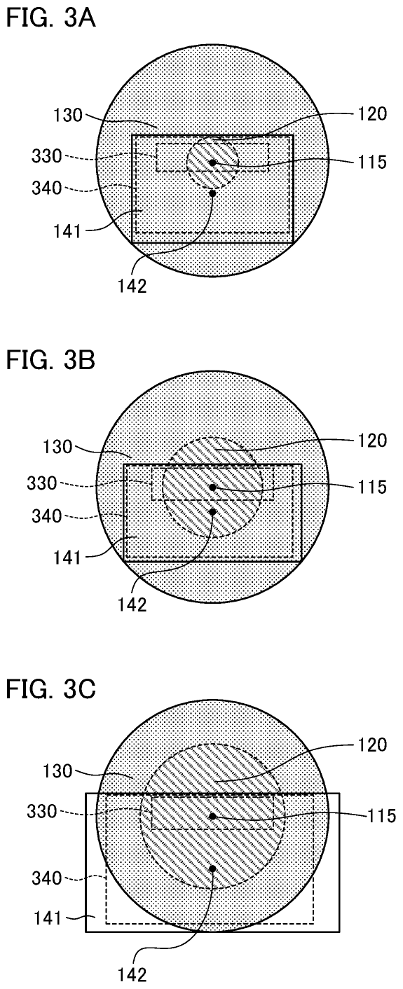

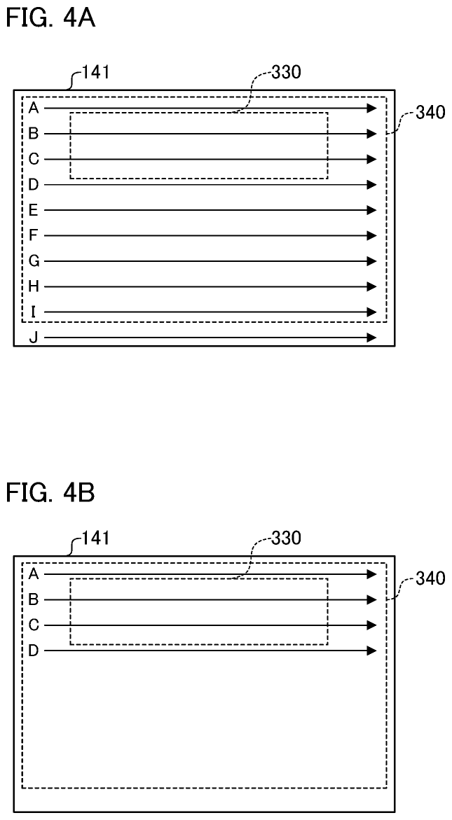

FIG. 1 is a side view of a moving device 10 in an embodiment. FIG. 2 is a block diagram illustrating a configuration of an imaging assembly 20 in the embodiment. FIGS. 3A to 3C are diagrams illustrating a positional relationship between a light receiving surface 141 of an imaging element 140 and a subject image formed by an optical system 110. FIGS. 4A and 4B are diagrams illustrating a relationship between a read region of the imaging element 140 and a frame rate.

The moving device 10 is a device that can move manually or automatically. Although an example in which the moving device 10 is a vehicle (for example, an automobile) is described in the embodiment and other embodiments, the moving device 10 may be an unmanned aerial vehicle (for example, a drone) or a robot that can move manually or automatically.

The moving device 10 is configured such that a driver 500 can board and the driver 500 can move to any place. A rear bumper 201 for relieving an impact if the moving device 10 and an object behind (for example, another moving device) collide with each other is attached to a rear portion of the moving device 10. In FIG. 1, a forward direction of the moving device 10 is defined as a +Y direction, and an upward direction perpendicular to the ground is defined as a +Z direction.

As illustrated in FIG. 1, an imaging device 100 is installed at the rear portion of the moving device 10. An optical axis 115 is an optical center of the optical system 110 included in the imaging device 100. Details of the optical system 110 will be described later. A high resolution field of view range 300 indicates a range in which a captured image having a high resolution is generated in a range captured by the imaging device 100. A captured image of a side behind and distant from the moving device 10 is obtained from the high resolution field of view range 300.

A normal resolution field of view range 310 indicates a range in which a captured image having a resolution lower than the resolution of a captured image generated by the high resolution field of view range 300 among ranges captured by the imaging device 100 is generated. The normal resolution field of view range 310 is wider than the high resolution field of view range 300 and includes the high resolution field of view range 300. A captured image of a side behind and near the moving device 10 is obtained from the high resolution field of view range 300.

The imaging device 100 is disposed, for example, at the rear portion of the moving device 10 and at a position higher than the rear bumper 201. A positional relationship between the imaging device 100 and the rear bumper 201 is, for example, a positional relationship in which a portion of the rear bumper 201 falls within the normal resolution field of view range 310. For this reason, a captured image obtained from the normal resolution field of view range 310 includes an image of the portion of the rear bumper 201.

A captured image obtained from the normal resolution field of view range 310 is displayed on a second display unit 410. The driver 500 can visually recognize a positional relationship and a distance between an object (or a person) positioned behind and near the moving device 10 and a portion of the rear bumper 201 by viewing the captured image displayed on the second display unit 410. The driver 500 can safely move the moving device 10 backward by operating the moving device 10 while viewing the captured image displayed on the second display unit 410.

Next, a configuration of the imaging assembly 20 that can be installed in the moving device 10 of the embodiment will be described with reference to FIG. 2.

As illustrated in FIG. 2, the imaging assembly 20 includes the imaging device 100, an image processing device 160, a detection unit 190, a shift lever 191, a first display unit 400, and the second display unit 410. However, components of the imaging assembly 20 are not limited thereto.

The imaging device 100 includes an optical system 110, an imaging element 140, and a control unit 143. However, components of the imaging device 100 are not limited thereto.

The image processing device 160 includes a control unit 170 and a memory unit 180. However, components of the image processing device 160 are not limited thereto. Note that the image processing device 160 may be one of the components of the imaging device 100 or may be a device different from the imaging device 100.

The optical system 110 is configured such that an image formation magnification near the optical axis 115 is high, and an image formation magnification becomes lower as a distance from the optical axis 115 increases. In addition, the optical system 110 is configured such that a subject image in the high resolution field of view range 300 is formed in a high resolution region 120 near the optical axis 115 as a high resolution image. Further, the optical system 110 is configured such that a subject image in the normal resolution field of view range 310 is formed in a normal resolution region 130 in the vicinity of the high resolution region 120 as a normal resolution image. Note that the optical system 110 is configured such that a resolution characteristic of a boundary portion between the high resolution region 120 and the normal resolution region 130 becomes lower gradually toward the normal resolution region 130. Such a configuration of the optical system 110 is disclosed in Japanese Patent Application No. 2021-011187, and an optical system disclosed in Japanese Patent Application No. 2021-011187 can be applied as the optical system 110.

The imaging element 140 performs photoelectric conversion of a subject image formed on a light receiving surface 141 through the optical system 110 to generate pixel data. As illustrated in FIGS. 3A to 3C, the light receiving surface 141 includes a first display region (first region) 330 and a second display region (second region) 340. The second display region 340 is larger than the first display region 330 and includes the first display region 330. The first display region 330 corresponds to a display region of the first display unit 400, and the second display region 340 corresponds to a display region of the second display unit 410. In this manner, the optical system 110 forms a high resolution image near an optical axis in the first display region (first region) 330 of the light receiving surface of the imaging element, and forms a low resolution image of a peripheral portion separated from the optical axis in the second display region (second region) 340 which is wider than a first region of the light receiving surface of the imaging element.

The imaging element 140 has a narrow view angle reading mode and a wide view angle reading mode. The narrow view angle reading mode is an operation mode for reading pixel data in a first read region (equivalent to A to D lines in FIG. 4B) of the imaging element 140 at a first frame rate (high frame rate) which is higher than a second frame rate (a normal frame rate, a low frame rate). The wide view angle reading mode is an operation mode for reading pixel data in a second read region (equivalent to A to J lines in FIG. 4A) of the imaging element 140 at the second frame rate (normal frame rate). The first read region is narrower than the second read region and includes the first display region 330 but does not include the second display region 340.

The second read region is wider than the first read region and includes the first display region 330 and the second display region 340. Since the first read region is narrower than the second read region, the time required for reading all pieces of pixel data in the first read region is shorter than the time required for reading all pieces of pixel data in the second read region. For this reason, the imaging element 140 is configured to perform reading of pixel data in the first read region at a frame rate higher than a frame rate in the wide view angle reading mode if an operation mode of the imaging element 140 is a narrow view angle reading mode.

The control unit 143 includes a memory that stores a program for controlling the imaging device 100 and a computer (for example, a CPU or a processor) that executes the program stored in the memory. The control unit 143 functions as a control unit that controls components of the imaging device 100. The control unit 143 can communicate with the control unit 170 of the image processing device 160.

If an operation mode of the imaging element 140 is a narrow view angle reading mode, the control unit 143 generates a captured image of a high frame rate from the pixel data in the first read region including the first display region 330. The captured image of a high frame rate is a captured image having a narrow view angle.

If an operation mode of the imaging element 140 is a wide view angle reading mode, the control unit 143 generates a captured image of a normal frame rate (a captured image having a wide view angle) from the pixel data in the second read region including the first display region 330 and the second display region 340. In this case, the control unit 143 functions as an image generation unit. The captured image of a normal frame rate is a captured image having a wide view angle. Both the captured image of a high frame rate and the captured image of a normal frame rate which are generated by the control unit 143 are supplied to the control unit 170 as moving image data having a predetermined data format.

The control unit 170 includes a memory that stores a program for controlling the image processing device 160 and a computer (for example, a CPU or a processor) which executes the program stored in the memory. The control unit 170 functions as a control unit that controls components of the image processing device 160. The control unit 170 can communicate with the control unit 143 of the imaging device 100 and can also communicate with the detection unit 190, the first display unit 400, and the second display unit 410. If an operation mode of the imaging element 140 is set to be a narrow view angle reading mode, the captured image of a high frame rate which is generated by the control unit 143 is stored in the memory unit 180. If an operation mode of the imaging element 140 is set to be a wide view angle reading mode, the captured image of a normal frame rate which is generated by the control unit 143 is stored in the memory unit 180.

The control unit 170 functions as an image processing unit that performs predetermined image processing (including distortion aberration correction) and image cutting processing on the captured image of a high frame rate and the captured image of a normal frame rate which are generated by the control unit 143. The control unit 170 performs distortion aberration correction on the captured image of a high frame rate and the captured image of a normal frame rate in order to correct distortion aberration of the optical system 110.

Note that the control unit 170 performs more stronger distortion aberration correction on a captured image in the second display region 340 (a captured image having a wide view angle) than on a captured image in the first display region 330 (a captured image having a narrow view angle). This is because distortion aberration which is larger than that of a subject image formed in the first display region 330 by the optical system 110 is included in a subject image formed in the second display region 340 by the optical system 110.

The shift lever 191 is a lever for changing the state of the moving device 10 to any one of parking, reverse, neutral, drive, or the like (second gear, low gear, or the like). The detection unit 190 detects to which one of parking, reverse, neutral, drive, and the like the lever position of the shift lever 191 corresponds and notifies the control unit 170 of a detection result.

The first display unit 400 is a display unit for visually recognizing the state behind when the moving device 10 travels forward, and is installed at, for example, a position similar to the line of sight of the driver 500. The first display unit 400 is, for example, a rear view mirror type display unit that functions as an electronic mirror.

The second display unit 410 is a display unit for visually recognizing the state behind when the moving device 10 travels backward, and is installed at, for example, a position lower than the line of sight of the driver 500. The second display unit 410 is, for example, a display unit that functions as a back monitor or a rear-view monitor.

Next, a positional relationship between the light receiving surface 141 of the imaging element 140 and a subject image formed by the optical system 110 will be described with reference to FIGS. 3A, 3B, and 3C.

FIGS. 3A to 3C illustrate a positional relationship between a subject image and the light receiving surface 141 in the state illustrated in FIG. 1. A light receiving surface center 142 which is the center of the light receiving surface 141 is disposed at a position shifted below the optical axis 115 which is an optical center of the optical system 110 as illustrated in FIGS. 3A to 3C.

By shifting the optical axis 115 to a −Z axis side in a Z direction with respect to the light receiving surface center 142 of the imaging element 140, the normal resolution field of view range 310 is configured such that a region on a +Z side becomes narrow and a region on a −Z side becomes wide with respect to the optical axis 115. For example, the normal resolution field of view range 310 can be set asymmetrically in an up-down direction. In this manner, a positional relationship of the first display region 330 and the second display region 340 with respect to the high resolution region 120 and the normal resolution region 130 can be set asymmetrically in the up-down direction (Z direction).

As described above, in the optical system 110, a subject image in the high resolution field of view range 300 is formed in the high resolution region 120 near the optical axis 115 as a high resolution image. Further, in the optical system 110, a subject image in the normal resolution field of view range 310 is formed in the normal resolution region 130 around the high resolution region 120 as a normal resolution image. By shifting the optical axis 115 to the −Z axis side in the Z direction with respect to the light receiving surface center 142 of the imaging element 140, the normal resolution field of view range 310 is configured such that a region on the +Z side becomes narrow and a region on the −Z side becomes wide with respect to the optical axis 115. Thereby, the normal resolution field of view range 310 can be set asymmetrically in the up-down direction.

In the example illustrated in FIG. 3A, a large number of high resolution images of the high resolution region 120 are included in the first display region 330 indicated by a dotted frame. In addition, a captured image (first captured image) of a high frame rate corresponding to the first display region 330 is displayed on the first display unit 400. Similarly, a captured image (second captured image) of a normal frame rate corresponding to the second display region 340 indicated by a dotted frame is displayed on the second display unit 410.

Note that, in the example illustrated in FIG. 3A, the first display region 330 includes a portion of the high resolution region 120 and a portion of the normal resolution region 130, and the second display region 340 includes the entirety of the high resolution region 120 and a portion of the normal resolution region 130. In the example illustrated in FIG. 3B, the first display region 330 includes a portion of the high resolution region 120 and a portion of the normal resolution region 130, and the second display region 340 also includes a portion of the high resolution region 120 and a portion of the normal resolution region 130. In the example illustrated in FIG. 3C, the first display region 330 includes only a portion of the high resolution region 120, and the second display region 340 includes a portion of the high resolution region 120, a portion of the normal resolution region 130, and a region which is neither the high resolution region 120 nor the normal resolution region 130.

A positional relationship of the first display region 330 and the second display region 340 with respect to the high resolution region 120 and the normal resolution region 130 is not limited to the examples of FIGS. 3A to 3C, and can be any one of various positional relationships. The positional relationship of the first display region 330 and the second display region 340 with respect to the high resolution region 120 and the normal resolution region 130 can be changed by changing, for example, a positional relationship of the high resolution region 120 and the normal resolution region 130 with respect to the light receiving surface 141. Alternatively, it is also possible to change the positional relationship by changing optical characteristics of the optical system 110.

Note that, although an example in which the high resolution field of view range 300 is a range centering on the optical axis 115 has been described in the embodiment, the center of the high resolution field of view range 300 and the optical axis 115 may be slightly deviated from each other. Similarly, the center of the normal resolution field of view range 310 and the optical axis 115 may also be slightly deviated from each other.

In addition, although an example in which the optical axis 115 and the light receiving surface center 142 of the imaging element 140 are vertically deviated from each other has been described in the embodiment, they may be deviated from each other, for example, horizontally or diagonally in accordance with the purpose of use of the imaging assembly 20.

Next, a relationship between a read region of the imaging element 140 and a frame rate will be described with reference to FIGS. 4A and 4B. Here, the frame rate is a unit indicating by how many frames (still images) a moving image for a second is constituted, and is represented by a unit of fps (frames per second).

For example, 30 fps represents that a moving image for a second is constituted by 30 frames. The higher a frame rate, the smoother the display of a moving image. If an image obtained by the imaging device 100 is used for various processing (object detection processing, image recognition processing, and the like) at the time of automated driving, the number of times of detection per unit time can be increased when a frame rate is high, and thus it is possible to perform rapid detection and highly reliable detection.

The imaging element 140 in the embodiment is, for example, a CMOS sensor, and pixel data is read through line exposure sequential reading. Here, the line exposure sequential reading is a method of generating pixel data corresponding to one frame by a plurality of lines, sequentially reading pixel data corresponding to one frame for each line to every several lines, and sequentially resetting the exposure of the read lines. For this reason, a reading time of pixel data of in the entire range of the light receiving surface 141 and a frame rate have the following relationship.

For example, if a still image (captured image) of each frame is generated at 30 fps described above, a display time per frame is approximately 1/30 seconds. Thus, when a reading time required to read pixel data of all lines of the light receiving surface 141 is assumed to be t, it is possible to read the pixel data of all lines of the light receiving surface 141 and display a captured image when t< 1/30 seconds. However, if t≥ 1/30 seconds, it is not possible to display a captured image even when all lines of the light receiving surface 141 are read.

FIG. 4A is a diagram illustrating a relationship between the second read region of the imaging element 140 and a frame rate. FIG. 4B is a diagram illustrating a relationship between the first read region of the imaging element 140 and a frame rate. Arrows illustrated in FIGS. 4A and 4B indicate a reading direction of each line at the time of reading a captured image (still image) of each frame. Hereinafter, for example, a case where a reading time per line (horizontal scanning period) is fixed will be described.

If an operation mode of the imaging element 140 is a wide view angle reading mode, pixel data in the second read region of the imaging element 140 is read at a second frame rate (normal frame rate, low frame rate). Here, the second read region of the imaging element 140 is equivalent to A to J lines in FIG. 4A, is wider than the first read region, and includes the first display region 330 and the second display region 340. For example, as illustrated in FIG. 4A, all regions of the light receiving surface 141 can be set to be second read regions. A captured image of a normal frame rate which is generated from pixel data in the second read region is displayed on the second display unit 410 (and the first display unit 400) as an image having a wide view angle.

If an operation mode of the imaging element 140 is a narrow view angle reading mode, pixel data in the first read region of the imaging element 140 is read at a first frame rate (high frame rate) higher than the second frame rate (normal frame rate). Here, the first read region of the imaging element 140 is equivalent to A to D lines in FIG. 4B, is narrower than the second read region, and includes the first display region 330 but does not include the second display region 340.

For example, as illustrated in FIG. 4B, a region equal to or less than one-half of the light receiving surface 141 can be set to be a first read region. A reading time of pixel data corresponding to one frame can be reduced by using such an imaging element 140, and thus a frame rate can be increased. A captured image of a high frame rate which is generated from pixel data in the first read region is displayed on the first display unit 400 as an image having a narrow view angle.

In this manner, the first read region is narrower than the second read region, and thus a time required for reading all pieces of pixel data in the first read region is shorter than a time required for reading all pieces of pixel data in the second read region. For this reason, it is possible to read the pixel data in the first read region at a frame rate higher than a frame rate in a wide view angle reading mode without increasing a reading speed per line.

For example, when a region equal to or less than one-half of the light receiving surface 141 is set to be a first read region, it is possible to read pixel data in the first read region at a frame rate which is twice the frame rate in the wide view angle reading mode. For example, the frame rate in the wide view angle reading mode is set to 30 fps, and the frame rate in the narrow view angle reading mode is set to 60 fps. Thereby, it is possible to generate a high resolution captured image at a high frame rate by using an inexpensive imaging element and a peripheral circuit without increasing a reading speed per line.

Note that, although a configuration in which the second read region includes a leading line of the light receiving surface 141 is adopted in the embodiment, the disclosure is not limited thereto. For example, the imaging element 140 can be an imaging element that can read pixel data from a designated line. Thereby, it is also possible to selectively read a partial region including the first display region 330 and to further increase a frame rate if an operation mode of the imaging element 140 is a narrow view angle reading mode.

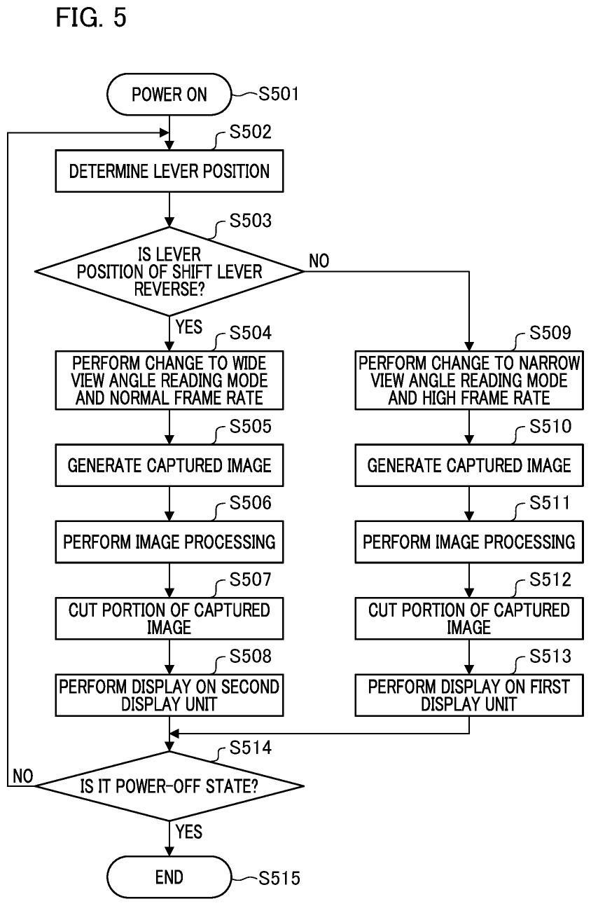

Next, imaging control processing performed by the imaging assembly 20 will be described with reference to a flowchart of FIG. 5. If an operation for setting the imaging assembly 20 to be in a power-on state is performed by a user, the process of step S501 is started. Note that the imaging control processing is controlled by executing a program stored in the memory of the control unit 170 by a computer of the control unit 170.

In step S501, the control unit 170 sets the imaging assembly 20 to be in a power-on state.

In step S502, the detection unit 190 detects to which one of parking, reverse, neutral, drive, and the like the lever position of the shift lever 191 corresponds and notifies the control unit 170 of a detection result. Thereby, the control unit 170 can know to which one of parking, reverse, neutral, drive, and the like the lever position of the shift lever 191 corresponds.

In step S503, the control unit 170 determines whether the lever position of the shift lever 191 is reverse. If it is determined that the lever position of the shift lever 191 is reverse, the control unit 170 proceeds to step S504. If it is determined that the lever position of the shift lever 191 is drive, the control unit 170 proceeds to step S509. Even if it is determined that the lever position of the shift lever 191 is a lever position (other than drive) for moving the moving device 10 forward, the control unit 170 proceeds to step S509.

In step S504, the control unit 170 controls the imaging device 100 to change an operation mode of the imaging element 140 to a wide view angle reading mode and change a frame rate of the imaging element 140 to a normal frame rate. The normal frame rate is equivalent to a first frame rate. Thereby, the imaging device 100 functions as an imaging device that generates a captured image having a wide view angle at a normal frame rate.

In step S505, the imaging element 140 captures an image of a side behind and near the moving device 10 at the first frame rate. Since the operation mode of the imaging element 140 is a wide view angle reading mode, pixel data in a first read region and a second read region including the second display region 340 is read from the imaging element 140 at a normal frame rate and is supplied to the control unit 143. The control unit 143 generates a captured image having a wide view angle at the normal frame rate from the pixel data in the second read region. The captured image of a normal frame rate which is generated by the control unit 143 is supplied to the control unit 170. Here, step S505 functions as an image generation unit (image generation step) that generates a second captured image.

In step S506, the control unit 170 stores the captured image of a normal frame rate which is generated by the control unit 143 in the memory unit 180 in order to perform predetermined image processing or the like. In addition, the control unit 170 performs predetermined image processing (including distortion aberration correction) on each captured image. Here, the control unit 170 functions as an image processing step (image processing unit) that performs distortion aberration correction on each captured image in order to correct distortion aberration of the optical system 110.

In step S507, the control unit 170 cuts out a portion equivalent to the second display region 340 from each captured image on which predetermined image processing has been performed. The second display region 340 is equivalent to a display region of the second display unit 410. Thereby, a captured image of a normal frame rate which can be displayed on the second display unit 410 is generated.

In step S508, the control unit 170 displays the captured image (second captured image) of a normal frame rate which is generated in step S507 on the second display unit 410 (a display unit that functions as a back monitor or a rear-view monitor). Thereby, a captured image having a wide view angle is displayed on the second display unit 410 at a normal frame rate. Note that the captured image of a normal frame rate which is generated in step S507 may be displayed on the first display unit 400 in response to a user's operation.

In step S509, the control unit 170 controls the imaging device 100 to change an operation mode of the imaging element 140 to a narrow view angle reading mode and change a frame rate of the imaging element 140 to a high frame rate. The high frame rate is equivalent to a second frame rate higher than the first frame rate. Thereby, the imaging device 100 functions as an imaging device that generates a captured image having a narrow view angle but having a high resolution at a high frame rate.

In step S510, the imaging element 140 captures a side behind and distant from the moving device 10 at the second frame rate. Since the operation mode of the imaging element 140 is a narrow view angle reading mode, pixel data in the first read region narrower than the second read region is read from the imaging element 140 at a high frame rate and is supplied to the control unit 143. The control unit 143 generates a captured image having a narrow view angle but having a high resolution from the pixel data in the first read region at a high frame rate. The captured image of a high frame rate which is generated by the control unit 143 is supplied to the control unit 170. Here, step S510 functions as an image generation unit (image generation step) that generates a first captured image.

In step S511, the control unit 170 stores the captured image of a high frame rate which is generated by the control unit 143 in the memory unit 180 in order to perform predetermined image processing or the like. In addition, the control unit 170 performs predetermined image processing (including distortion aberration correction) on each captured image. For example, the control unit 170 performs distortion aberration correction on each captured image in order to correct distortion aberration of the optical system 110.

In step S512, the control unit 170 cuts out a portion equivalent to the first display region 330 from each captured image on which predetermined image processing has been performed. The first display region 330 is equivalent to a display region of the first display unit 400. Thereby, a captured image of a high frame rate which can be displayed on the first display unit 400 is generated.

In step S513, the control unit 170 displays the captured image (first captured image) of a high frame rate which is generated in step S512 on the first display unit 400 (a rear view mirror type display unit that functions as an electronic mirror). Thereby, a captured image having a narrow view angle but having a high resolution is displayed on the first display unit 400 at a high frame rate. Here, steps S513 and S508 function as control steps of selectively displaying the first captured image and the second captured image on a display unit in accordance with a moving direction of a moving device.

In step S514, the control unit 170 determines whether to set the imaging assembly 20 to be in a power-off state. If the imaging assembly 20 is set to be in a power-off state, the imaging control processing proceeds to step S515. If the imaging assembly 20 is not set to be in a power-off state, the imaging control processing proceeds to step S502.

In step S515, the control unit 170 terminates the imaging control processing and sets the imaging assembly 20 to be in a power-off state.

Note that, if it is determined in step S503 that the lever position of the shift lever 191 is neutral or parking, the control unit 170 may proceed to step S504 or may proceed to step S509.

As described above, according to the embodiment, the imaging device 100 can function as an imaging device that generates a captured image having a narrow view angle but having a high resolution at a high frame rate and can also function as an imaging device that generates a captured image having a wide view angle at a normal frame rate.

Further, according to the imaging device 100 of the embodiment, if the moving device 10 travels forward, a captured image having a narrow view angle but having a high resolution can be generated at a high frame rate. In addition, the high resolution captured image generated at a high frame rate is displayed on the first display unit 400. Thereby, even if the moving device 10 travels forward at high speed, a captured image of a side behind and distant from the moving device 10 is smoothly displayed on the first display unit 400.

Further, according to the imaging device 100 of the embodiment, if the moving device 10 travels backward, a captured image having a wide view angle can be generated at a normal frame rate (low frame rate). In addition, the captured image having a normal resolution which is generated at a normal frame rate is displayed on the second display unit 410. Thereby, if the moving device 10 travels backward, a user can visually recognize an object (or a person) behind and close to the moving device 10.

Note that, in the embodiment, if the moving device 10 travels forward, an operation mode of the imaging element 140 is set to be a narrow view angle reading mode, and a captured image of a high frame rate can be generated. For this reason, for example, if the moving device 10 travels forward, the control unit 170 can perform various processing (including object detection processing and image recognition processing) using a captured image of a high frame rate. By causing the control unit 170 to perform object detection processing using a captured image of a high frame rate, it is possible to more rapidly and accurately perform determination regarding whether an object is present behind, or the like.

Further, by causing the control unit 170 to perform image recognition processing using a captured image of a high frame rate, it is also possible to more rapidly and accurately perform reading of a number plate of a vehicle behind, or the like. Such object detection processing and image recognition processing can be used if the moving device 10 travels forward in an automatic travel mode (or an automatic driving mode). Various processing (object detection processing, image recognition processing, and the like) using a captured image of a high frame rate may be performed by an image processing unit different from the control unit 170.

In the embodiment, if the moving device 10 travels forward, a frame rate of the imaging element 140 is changed to a second frame rate (high frame rate), but the embodiment is not limited thereto. For example, if the moving device 10 travels forward, the frame rate of the imaging element 140 may be changed to the second frame rate or a third frame rate which is higher than the second frame rate in accordance with the speed at which the moving device 10 travels forward.

Alternatively, as the speed at which the moving device 10 travels forward becomes higher, the frame rate of the imaging element 140 may be increased. In this manner, a captured image generated during high-speed traveling is further smoothly displayed, and thus visibility can be further improved. Further, it is possible to more rapidly and accurately perform determination regarding whether an object is present behind, reading of a number plate of a vehicle behind, and the like.

In the embodiment, the control unit 170 determines a moving direction of the moving device 10 on the basis of the lever position of the shift lever 191 and changes an operation mode of the imaging element 140 on the basis of the determined moving direction. However, a method of determining a moving direction of the moving device 10 is not limited thereto. For example, a rotation direction detection unit that detects a rotation direction of a driving wheel (tire) of the moving device 10 may be installed in the moving device 10, and the control unit 170 may be notified of a detection result of the rotation direction detection unit.

In this case, the control unit 170 determines a moving direction of the moving device 10 on the basis of the detection result of the rotation direction detection unit and changes an operation mode of the imaging element 140 on the basis of the determined moving direction. Thereby, if the moving direction of the moving device 10 is a forward direction, the operation mode of the imaging element 140 is changed to a narrow view angle reading mode, and if the moving direction of the moving device 10 is a backward direction, the operation mode of the imaging element 140 is changed to a wide view angle reading mode.

The moving direction of the moving device 10 can also be determined on the basis of a difference between a plurality of first captured images or a difference between a plurality of second captured images. That is, the control unit 170 may determine the moving direction of the moving device 10 on the basis of a difference between a plurality of captured images and may change the operation mode of the imaging element 140 on the basis of the determined moving direction. Thereby, if the moving direction of the moving device 10 is a forward direction, the operation mode of the imaging element 140 is changed to a narrow view angle reading mode, and if the moving direction of the moving device 10 is a backward direction, the operation mode of the imaging element 140 is changed to a wide view angle reading mode.

The moving direction of the moving device 10 can also be determined on the basis of information obtained by a GPS sensor or an acceleration sensor. For example, the GPS sensor or the acceleration sensor may be installed in the moving device 10, and the control unit 170 may be notified of the information obtained by the GPS sensor or the acceleration sensor. In this case, the control unit 170 determines the moving direction of the moving device 10 on the basis of the information obtained by the GPS sensor or the acceleration sensor and changes the operation mode of the imaging element 140 on the basis of the determined moving direction. Thereby, if the moving direction of the moving device 10 is a forward direction, the operation mode of the imaging element 140 is changed to a narrow view angle reading mode, and if the moving direction of the moving device 10 is a backward direction, the operation mode of the imaging element 140 is changed to a wide view angle reading mode.

The moving direction of the moving device 10 can also be determined on the basis of a rotation direction of a motor that drives the driving wheel (tire) of the moving device 10. For example, a driving control signal for controlling the rotation direction of the motor that drives the driving wheel (tire) of the moving device 10 may be supplied to the control unit 170. In this case, the control unit 170 determines a moving direction of the moving device 10 on the basis of the driving control signal and changes an operation mode of the imaging element 140 on the basis of the determined moving direction. Thereby, if the moving direction of the moving device 10 is a forward direction, the operation mode of the imaging element 140 is changed to a narrow view angle reading mode, and if the moving direction of the moving device 10 is a backward direction, the operation mode of the imaging element 140 is changed to a wide view angle reading mode. Here, the motor functions as a moving control unit that controls the movement of the moving device, but the moving control unit may be an engine or the like.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-091767 filed on May 31, 2021, which is hereby incorporated by reference herein in its entirety.

What is claimed is:

1. An assembly mounted on a moving device, the assembly comprising:
an element;
an optical system configured to form a high resolution image near an optical axis in a first region of a light receiving surface of the element and form a low resolution image of a peripheral portion separated from the optical axis in a second region wider than the first region of the light receiving surface of the element;
at least one processor and a memory coupled to the processor storing instructions that, when executed by the processor, cause the processor to function as:
a generation unit configured to generate a first captured image from pixel data in the first region and generate a second captured image from pixel data in the second region; and
a control unit configured to selectively display the first captured image or the second captured image on a display unit in accordance with a moving direction of the moving device.

2. The assembly according to claim 1, wherein the optical system has a characteristic having a high image formation magnification near the optical axis and a low image formation magnification in the peripheral portion.

3. The assembly according to claim 2, further comprising:
a processing unit configured to perform distortion aberration correction of the optical system on the first captured image and the second captured image.

4. The assembly according to claim 3, wherein the processing unit performs distortion aberration correction more strongly on an image corresponding to the low resolution image of the peripheral portion than on an image corresponding to the high resolution image near the optical axis.

5. The assembly according to claim 3, wherein the processing unit detects whether an object is present or performs image recognition of an object based on the first captured image.

6. The assembly according to claim 1, wherein the generation unit generates the first captured image of a high frame rate from the pixel data in the first region and generates the second captured image of a low frame rate from the pixel data in the second region.

7. The assembly according to claim 1, wherein the control unit determines the moving direction in accordance with a lever position of a shift lever for controlling the moving direction of the moving device.

8. The assembly according to claim 1, wherein the control unit determines the moving direction in accordance with a rotation direction of a driving wheel of the moving device.

9. The assembly according to claim 1, wherein the control unit determines the moving direction on the basis of a difference between a plurality of the first captured images or a difference between a plurality of the second captured images.

10. The assembly according to claim 1, wherein the control unit determines the moving direction on the basis of a GPS sensor or an acceleration sensor mounted on the moving device.

11. The assembly according to claim 1, wherein the control unit determines the moving direction in accordance with a signal for controlling the moving direction of the moving device.

12. The assembly according to claim 1, wherein an image of a portion of the moving device is included in the second captured image.

13. A device comprising:
an element mounted on a moving device;
an optical system configured to form a high resolution image near an optical axis in a first region of a light receiving surface of the element and form a low resolution image of a peripheral portion separated from the optical axis in a second region wider than the first region of the light receiving surface of the element;
at least one processor and a memory coupled to the processor storing instructions that, when executed by the processor, cause the processor to function as:
a generation unit configured to generate a first captured image from pixel data in the first region and generate a second captured image from pixel data in the second region;
a control unit configured to selectively display the first captured image or the second captured image on a display unit in accordance with a moving direction of the moving device;
a moving control unit configured to control movement of the moving device; and
the display unit.

14. The device according to claim 13, wherein the optical system has a characteristic having a high image formation magnification near the optical axis and a low image formation magnification in the peripheral portion.

15. A method for an assembly including an element, and an optical system configured to form a high resolution image near an optical axis in a first region of a light receiving surface of the element and form a low resolution image of a peripheral portion in a second region wider than the first region of the light receiving surface of the element, the method comprising:
generating a first captured image from pixel data in the first region and generating a second captured image from pixel data in the second region; and
selectively displaying the first captured image and the second captured image on a display unit in accordance with a moving direction of the moving device.

16. The method according to claim 15, wherein the optical system has a characteristic having a high image formation magnification near the optical axis and a low image formation magnification in the peripheral portion.

17. The method according to claim 15, wherein the generating generates the first captured image of a high frame rate from the pixel data in the first region and generating the second captured image of a low frame rate from the pixel data in the second region.

18. A non-transitory computer-readable storage medium configured to store a computer program to control an assembly configured to have an element, and an optical system configured to form a high resolution image near an optical axis in a first region of a light receiving surface of the element and form a low resolution image of a peripheral portion in a second region wider than the first region of the light receiving surface of the element,
wherein the computer program comprises instructions for executing following processes of:
generating a first captured image from pixel data in the first region and generating a second captured image from pixel data in the second region, and
selectively displaying the first captured image and the second captured image on a display unit in accordance with a moving direction of the moving device.

19. The non-transitory computer-readable storage medium according to claim 18, wherein the optical system has a characteristic having a high image formation magnification near the optical axis and a low image formation magnification in the peripheral portion.

20. The non-transitory computer-readable storage medium according to claim 18, wherein the generating generates the first captured image of a high frame rate from the pixel data in the first region and generating the second captured image of a low frame rate from the pixel data in the second region.
